(19) United States
(12) Patent Application Publication
(10) Pub. No.: US 2009/0304572 A1
(43) Pub. Date: Dec. 10, 2009

(54) METHOD FOR THE PRODUCTION OF CHLORINE

(75) Inventors: Martin Sesing, Waldsee (DE); Knud Jacobsen, Ludwigshafen (DE); Klaus-Dieter Reinhardt, Ludwigshafen (DE); Hans-Juergen Pallasch, Kallastadt (DE); Peter Van Den Abeel, Brasschaat (BE); Heiner Schelling, Kirchheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/162,368

(22) PCT Filed: Jan. 26, 2007
(86) PCT No.: PCT/EP07/00696

§ 371 Date: Oct. 21, 2008

(30) Foreign Application Priority Data
Jan. 27, 2006 (EP) 06100941.1

(51) Int. Cl. C01B 7/04

(52) U.S. Cl. 423/502

(57) ABSTRACT

Process for preparing chlorine from hydrogen chloride, which comprises the steps:
a) feeding of a stream a1 comprising hydrogen chloride and of a stream a2 comprising oxygen into an oxidation zone and catalytic oxidation of hydrogen chloride to chlorine, giving a product gas stream a3 comprising chlorine, water, oxygen, carbon dioxide and inert gases;
b) contacting of the product gas stream a3 with aqueous hydrochloric acid I in a phase contact apparatus and partial separation of water and of hydrogen chloride from the stream a3, leaving a gas stream b comprising hydrogen chloride, chlorine, water, oxygen, carbon dioxide and possibly inert gases, with at least 5% of the hydrogen chloride comprised in the stream a3 remaining in the gas stream b;
c) drying of the gas stream b) to leave a gas stream c which is substantially free of water and comprises hydrogen chloride, chlorine, oxygen, carbon dioxide and possibly inert gases;
d) partial liquefaction of the gas stream c by compression and cooling, giving an at least partially liquefied stream d;
e) gas/liquid separation of the stream d into a gas stream e1 comprising chlorine, oxygen, carbon dioxide, hydrogen chloride and possibly inert gases and a liquid stream e2 comprising hydrogen chloride, chlorine, oxygen and carbon dioxide and, if appropriate, recirculation of at least part of the gas stream e1 to step a);
f) separation of the liquid stream e2 into a chlorine stream f1 and a stream f2 consisting essentially of hydrogen chloride, oxygen and carbon dioxide by distillation in a column, with part of the hydrogen chloride condensing at the top of the column and running back as runback into the column, as a result of which a stream f2 having a chlorine content of <1% by weight is obtained.

The invention relates to a process for preparing chlorine by catalytic oxidation of hydrogen chloride.

In the process developed by Deacon in 1868 for the catalytic oxidation of hydrogen chloride, hydrogen chloride is oxidized to chlorine by means of oxygen in an exothermic equilibrium reaction. The conversion of hydrogen chloride into chlorine enables chlorine production to be decoupled from the production of sodium hydroxide by chloralkali electrolysis. Such decoupling is attractive since the world demand for chlorine is growing more quickly than the demand for sodium hydroxide. In addition, hydrogen chloride is obtained in large quantities as coproduct in, for example, phosgenation reactions, for example in isocyanate production. The hydrogen chloride formed in isocyanate production is mostly used in the oxychlorination of ethylene to 1,2-dichlorethane, which is further processed to vinyl chloride and finally to PVC.

EP-A 0 765 838 discloses a process for working up the reaction gas comprising chlorine, hydrogen chloride, oxygen and water vapor which is formed in the oxidation of hydrogen chloride, in which the reaction gas leaving the oxidation reactor is cooled to such an extent that water of reaction and hydrogen chloride condense out in the form of concentrated hydrochloric acid, the concentrated hydrochloric acid is separated off from the reaction gas and is discharged, the remaining reaction gas which has been freed of virtually all the water and part of the hydrogen chloride is dried, the dried reaction gas comprising chlorine, oxygen and hydrogen chloride is compressed to from 1 to 30 bar and the compressed reaction gas is cooled and thus mostly liquefied, with components of the reaction gas which cannot be condensed out being at least partly recirculated to the oxidation reactor.

To separate off the chlorine, the dried and compressed reaction gas mixture is liquefied in a chlorine recuperator configured as an expansion cooler to leave only a small residual proportion of from about 10 to 20%. The main liquid chlorine stream which has been separated off in the chlorine recuperator is subsequently purified further in a distillation column in which the chlorine is freed of residual dissolved hydrogen chloride, oxygen and inert gases. The gas comprising essentially hydrogen chloride, chlorine, oxygen and inert gases which is taken off at the top of the distillation column is recirculated to the compression stage. The gas components which are not condensed out in the chlorine recuperator, including the residual proportion of chlorine, are partly liquefied at a significantly lower temperature in an after-cooling stage. The remaining offgas comprising unreacted hydrogen chloride, oxygen and inert gases is recycled to the oxidation reactor. Part of the recycled gas is separated off as a purge stream and is discharged from the process to prevent accumulation of impurities.

The hydrogen chloride used in the Deacon reaction is frequently gaseous hydrogen chloride obtained as coproduct in other production processes, for example in isocyanate production.

A disadvantage of the processes of the prior art in which chlorine is separated off from the chlorine-comprising product gas stream from the oxidation of hydrogen chloride exclusively by condensation is that very low temperatures are required in order to free the product gas stream of most of the chlorine. In addition, the residual gas stream comprising the uncondensable gas constituents still comprises considerable amounts of inert gases including carbon dioxide. In the recirculation of the oxygen-comprising residual gas stream to the hydrogen chloride oxidation reactor, these would accumulate to impermissibly high levels, so that a purge stream has to be separated off from this residual gas stream and discharged from the process before the residual gas stream is recirculated to the oxidation of hydrogen chloride. However, this purge stream still comprises appreciable amounts of chlorine, since the chlorine is only incompletely separated off by condensation. Thus, appreciable amounts of chlorine are lost in the purge stream.

It is an object of the invention to provide an improved process for preparing chlorine from hydrogen chloride, and in particular to remedy the disadvantages of the prior art.

This object is achieved by a process for preparing chlorine from hydrogen chloride, which comprises the steps:
a) feeding of a stream a1 comprising hydrogen chloride and of a stream a2 comprising oxygen into an oxidation zone and catalytic oxidation of hydrogen chloride to chlorine, giving a product gas stream a3 comprising chlorine, water, oxygen, hydrogen chloride, carbon dioxide and inert gases;
b) contacting of the product gas stream a3 with aqueous hydrochloric acid I in a phase contact apparatus and partial separation of water and of hydrogen chloride from the stream a3, leaving a gas stream b comprising hydrogen chloride, chlorine, water, oxygen, carbon dioxide and possibly inert gases, with at least 5% of the hydrogen chloride comprised in the stream a3 remaining in the gas stream b;
c) drying of the gas stream b) to leave a gas stream c which is substantially free of water and comprises hydrogen chloride, chlorine, oxygen, carbon dioxide and possibly inert gases;
d) partial liquefaction of the gas stream c by compression and cooling, giving an at least partially liquefied stream d;
e) gas/liquid separation of the stream d into a gas stream e1 comprising chlorine, oxygen, carbon dioxide and possibly inert gases and a liquid stream e2 comprising hydrogen chloride, chlorine, oxygen and carbon dioxide and, if appropriate, recirculation of at least part of the gas stream e1 to step a);
f) separation of the liquid stream e2 into a chlorine stream f1 and a stream f2 consisting essentially of hydrogen chloride, oxygen and carbon dioxide by distillation in a column, with part of the hydrogen chloride condensing at the top of the column and running back as runback into the column, as a result of which a stream f2 having a chlorine content of <1% by weight is obtained.

The feed gas stream a1 comprising hydrogen chloride which is used in the process step a) is usually an HCl-comprising stream which is obtained as off-stream in a process in which hydrogen chloride is formed as coproduct. Said processes are, for example,

(1) isocyanate production from phosgene and amines,

(2) acid chloride production,

(3) polycarbonate production,

(4) production of vinyl chloride from ethylene dichloride,

(5) chlorination of aromatics.

The HCl-comprising feed gas stream a1 can comprise secondary constituents. It usually comprises impurities which can be either organic or inorganic in nature. Organic impurities are, for example, hydrocarbons or chlorinated hydrocarbons. Typical hydrocarbons which may be present in the HCl-comprising feed gas streams used according to the invention comprise aromatics such as benzene, toluene, xylenes and C₆-C₁₂-aliphatics. Typical chlorinated hydrocarbons comprise phosgene, monochlorobenzene, dichlorobenzene, carbon tetrachloride, vinyl chloride and dichloroethane. The hydrocarbons and chlorinated hydrocarbons can be present in amounts up to 20% by volume, in general up to 30 000 ppm, preferably in amounts of up to 10 000 ppm and in particular in amounts of from 100 to 3000 ppm. Inorganic secondary constituents which can be present are, for example, carbon monoxide, carbon dioxide, nitrogen and further inert gases, generally in amounts of up to 10% by volume, preferably in amounts of up to 1% by volume.

The HCl-comprising feed stream a1 is preferably prepurified by passage over a purification bed and adsorption of hydrocarbons present in it on the purification bed before it is introduced into the oxidation zone. The purification bed comprises suitable adsorbents, preferably in the form of bodies such as spheres, extrudates or pellets. Suitable materials which can be used as adsorbents are, for example, activated carbon, aluminum oxide, titanium oxide, silicon dioxide, iron oxide, zeolites and molecular sieves. Suitable materials can also comprise metal oxides or metal halides, e.g. copper or ruthenium oxides or halides or mixtures thereof, on a support comprising a refractory inorganic material such as aluminum oxide, titanium oxide or silicon dioxide. Preferred adsorbents are aluminum oxide, activated carbon and clay minerals.

In the oxidation step a), the stream a1 comprising hydrogen chloride is fed together with a stream a2 comprising oxygen into an oxidation zone and is oxidized catalytically.

In the catalytic process also known as the Deacon process, hydrogen chloride is oxidized to chlorine by means of oxygen in an exothermic equilibrium reaction, with water vapor being formed. Customary reaction temperatures are in the range from 150 to 500° C., and customary reaction pressures are in the range from 1 to 25 bar. It is also advantageous to use oxygen in superstoichiometric amounts. It is usual to use, for example, a two- to four-fold excess of oxygen. Since no decreases in selectivity are to be feared, it can be economically advantageous to work at relatively high pressures and accordingly at residence times which are longer than those employed under atmospheric pressure.

Suitable catalysts comprise, for example, ruthenium oxide, ruthenium chloride or other ruthenium compounds on silicon dioxide, aluminum oxide, titanium dioxide or zirconium dioxide as support. Suitable catalysts can be obtained, for example, by application of ruthenium chloride to the support and subsequent drying or drying and calcination. Suitable catalysts can further, in addition to or in place of a ruthenium compound, comprise compounds of other noble metals, for example gold, palladium, platinum, osmium, iridium, silver, copper or rhenium. Suitable catalysts can further comprise chromium (III) oxide.

Also suitable are catalysts which comprise, on a support, from 0.001 to 30% by weight of gold, from 0 to 3% by weight of one or more alkaline earth metals, from 0 to 3% by weight of one or more alkali metals, from 0 to 10% by weight of one or more rare earth metals and from 0 to 10% by weight of one or more further metals selected from the group consisting of ruthenium, palladium, platinum, osmium, iridium, silver, copper and rhenium, in each case based on the total weight of the catalyst.

Such gold-comprising supported catalysts have a higher activity in the oxidation of hydrogen chloride than the ruthenium-comprising catalysts of the prior art, especially at temperatures of <250° C.

Customary reaction apparatuses in which the catalytic oxidation of hydrogen chloride is carried out are fixed-bed or fluidized-bed reactors. The oxidation of hydrogen chloride can be carried out in a plurality of stages.

The catalytic oxidation of hydrogen chloride can be carried out adiabatically or preferably isothermally or approximately isothermally, batchwise or preferably continuously, as a fluidized-bed or fixed-bed process. It is preferably carried out in a fluidized-bed reactor at a temperature of from 320 to 400° C. and a pressure of 2-8 bar.

In the isothermal or approximately isothermal mode of operation, it is also possible to use a plurality of reactors, i.e. from 2 to 10, preferably from 2 to 6, particularly preferably from 2 to 5, in particular from 2 to 3 reactors, connected in series with additional intermediate cooling. Either the oxygen can all be added together with the hydrogen chloride before the first reactor or its addition can be distributed over the various reactors. This arrangement of individual reactors in series can also be combined in one apparatus.

One embodiment comprises using a structured catalyst bed in which the catalyst activity increases in the flow direction in the fixed-bed reactor. Such structuring of the catalyst bed can be achieved by different impregnation of the catalyst supports with active composition or by different dilution of the catalyst with an inert material. As inert materials, it is possible to use, for example, rings, cylinders or spheres of titanium dioxide, zirconium dioxide or mixtures thereof, aluminum oxide, steatite, ceramic, glass, graphite or stainless steel. In the case of the preferred use of shaped catalyst bodies, the inert material should preferably have similar external dimensions.

Any shapes are suitable as shaped catalyst bodies; preference is given to pellets, rings, cylinders, stars, spoked wheels or spheres, particularly preferably rings, cylinders or star extrudates.

Suitable heterogeneous catalysts are, in particular, ruthenium compounds or copper compounds on support materials, and these can also be doped, with preference being given to doped or undoped ruthenium catalysts. Suitable support materials are, for example, silicon dioxide, graphite, titanium dioxide having the rutile or anatase structure, zirconium dioxide, aluminum oxide or mixtures thereof, preferably titanium dioxide, zirconium dioxide, aluminum oxide or mixtures thereof, particularly preferably gamma- or alpha-aluminum oxide or mixtures thereof.

The supported copper or ruthenium catalysts can, for example, be obtained by impregnating the support material with aqueous solutions of CuCl₂ or RuCl₃ and, if appropriate, a promoter for doping, preferably in the form of their chlorides. Shaping of the catalyst can be carried out after or preferably before impregnation of the support material.

Promoters suitable for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The support material can, after impregnation and doping, be dried and if appropriate calcined at temperatures of from 100 to 500° C., preferably from 100 to 400° C., for example under a nitrogen, argon or air atmosphere. It is preferably firstly dried at from 100 to 200° C. and subsequently calcined at from 200 to 400° C.

The volume ratio of hydrogen chloride to oxygen at the reactor inlet is generally from 1:1 to 20:1, preferably from 2:1 to 8:1, particularly preferably from 2:1 to 5:1.

In a step b), the product gas stream a3 is brought into contact with aqueous hydrochloric acid I in a phase contact apparatus and water and hydrogen chloride are partly separated off from the stream a3, leaving a gas stream b comprising hydrogen chloride, chlorine, water, oxygen, carbon dioxide and possibly inert gases. In this step, which can also be referred to as quenching and absorption step, the product gas stream a3 is cooled and water and hydrogen chloride are partly separated off from the product gas stream a3 as aqueous hydrochloric acid. The hot product gas stream a3 is cooled by bringing it into contact with dilute hydrochloric acid I as quenching medium in a suitable phase contact apparatus, for example a packed or tray column, a jet scrubber or a spray tower, with part of the hydrogen chloride being absorbed in the quenching medium. The quenching and absorption medium is hydrochloric acid which is not saturated with hydrogen chloride. However, the hydrogen chloride concentration of the hydrochloric acid I and the process conditions of the quenching and absorption step b) are selected so that hydrogen chloride is not separated off completely from the product gas stream a3 but remains partly in the gas stream b leaving the phase contact apparatus. The presence of hydrogen chloride in the gas stream b has important advantages in the subsequent chlorine distillation (step f)). At least 5%, generally from 5 to 80%, preferably from 10 to 60% and particularly preferably from 15 to 40%, of the hydrogen chloride comprised in the product gas stream a3 remains in the gas stream b.

The hydrochloric acid I preferably has a hydrogen chloride concentration of from 27 to 35% by weight. The temperature of the hydrochloric acid I in the phase contact apparatus is usually from 0 to 150° C., preferably from 30 to 100° C., and the pressure in the phase contact apparatus is usually from 0.5 to 20 bar, preferably from 1 to 10 bar. The offgas stream a3 can be cooled, for example in a heat exchanger, before it enters the phase contact apparatus.

In a preferred embodiment of the process of the invention, the phase contact apparatus has two stages, with the first stage being a pipe quench apparatus and the second stage being a falling film heat exchanger. This design of the phase contact apparatus as a pipe quench has the advantage that no expensive corrosion-resistant material such as tantalum has to be used, since the parts of the quenching apparatus which come into contact with the product come into contact only with cooled hydrochloric acid. It is therefore possible to use inexpensive materials such as graphite.

In a specific embodiment of the process of the invention, the phase contact apparatus has the following configuration: the first of two stages is designed as a pipe quench. This comprises vertical tubes, known as the pipes, into which the circulating liquid, in the present case the aqueous hydrochloric acid I, which is present between the tubes, is carried by the gas into the tubes. The cooling circulating liquid is broken up into small droplets in the region of the tops of the quenching tubes. The high turbulence and the large exchange area between gas and liquid results in very good heat and mass transfer. Circulating liquid and gas move in cocurrent. The second, downstream stage is a falling film heat exchanger which is configured as a shell-and-tube apparatus. Reaction gas and circulating liquid (hydrochloric acid) are conveyed in cocurrent through the tubes. The shell-and-tube apparatus is preferably cooled by means of water. The hydrogen chloride content of the gas stream b can be controlled by setting of the temperature of the falling film heat exchanger. A small vessel in which liquid and gas separate is located at the bottom of the apparatus. The liquid is returned to the pipe quench apparatus (first stage) as circulating liquid. In addition, the aqueous hydrochloric acid II obtained in the subsequent hydrochloric acid distillation is fed to the pipe quench.

In a preferred embodiment of the process of the invention, a section filled with packing is inserted between the pipe quench and the falling film heat exchanger. This ensures sufficient mixing, particularly during start-up and shutdown and low load operation, since mixing is then no longer sufficient in the pipe quench owing to the reduced turbulence.

Before the circulating hydrochloric acid is reintroduced into the pipe quench, it can be cooled in an additional heat exchanger installed upstream of the pipe quench. The reduction in temperature of the hydrochloric acid fed to the pipe quench allows, at the same temperature of the hydrochloric acid leaving the pipe quench, the circulating amount to be reduced. If, in contrast, the additional heat exchanger were to be omitted and instead the outflow temperature of the hydrochloric acid in the falling film heat exchanger were to be reduced too much, an excessively high solubility of hydrogen chloride in the aqueous hydrochloric acid could result. In a preferred embodiment of the process of the invention, this additional heat exchanger is configured as a plate heat exchanger.

In general, the phase contact apparatus is operated using circulating hydrochloric acid I. In a preferred embodiment, at least part of the aqueous hydrochloric acid circulating in the phase contact apparatus, for example from 1 to 20%, is taken off from the phase contact apparatus and subsequently distilled to give gaseous hydrogen chloride and an aqueous hydrochloric acid II which has been depleted in hydrogen chloride, with the hydrogen chloride being recirculated to step a) and at least part of the aqueous hydrochloric acid II being recirculated to the phase contact apparatus.

The hydrochloric acid distillation can be carried out in a plurality of stages. For example, a pressure distillation in which hydrogen chloride is obtained at the top of the column and constant-boiling, dilute hydrochloric acid having a hydrogen chloride content in the range of, for example, 15-22% by weight is obtained at the bottom can be carried out first. The bottom offtake stream from the pressure distillation column is subsequently subjected to a vacuum distillation in which water is obtained at the top of the vacuum distillation column and a more highly concentrated constant-boiling hydrochloric acid having a hydrogen chloride content of, for example, 20-28% by weight is obtained at the bottom of the column. The hydrochloric acid obtained in the pressure distillation and the vacuum distillation can in each case be recirculated partly or in its entirety (as hydrochloric acid II) to the phase contact apparatus and be combined with the circulating liquid.

In a further preferred embodiment, the aqueous hydrochloric acid I taken off from the phase contact apparatus is stripped to make it essentially chlorine-free before the hydrochloric acid distillation is carried out. At least part of the oxygen-comprising stream a2 which is fed to the oxidation zone, which can be fresh oxygen-comprising gas or circulating gas (gas stream e2), is preferably used for this purpose. Stripping can be carried out in a conventional stripping column. The chlorine content of the hydrochloric acid I can be reduced to <100 ppm, preferably <10 ppm, in this way.

Part of the stripped, essentially chlorine-free hydrochloric acid I can be separated off before the hydrochloric acid distillation is carried out and be combined with part of the aqueous hydrochloric acid II obtained in the hydrochloric acid distillation, for example the azeotropic acid from the pressure distillation. In this way, it is possible to produce a chlorine-free, in-specification hydrochloric acid of a particular concentration.

The stripping of the hydrochloric acid I to free it of chlorine has the additional advantage that any downstream heat exchanger in which the hydrochloric acid is heated before the distillation does not have to be made of an expensive corrosion-resistant material such as tantalum but can be made of an inexpensive material such as graphite.

The gas stream b leaving the phase contact apparatus comprises chlorine, hydrogen chloride, water, oxygen, carbon dioxide and generally also inert gases (mainly nitrogen if air is used as oxygen-comprising gas). This can be freed of traces of moisture by bringing it into contact with suitable desiccants in a subsequent drying step c). Suitable desiccants are, for example, concentrated sulfuric acid, molecular sieves or hygroscopic adsorbents. A gas stream c which is substantially free of water and comprises chlorine, oxygen, carbon dioxide and possibly inert gases is obtained.

Before the drying step c), the gas stream b is generally cooled. The presence of hydrogen chloride results in chlorine not crystallizing out as chlorine hydrate at temperatures of <10° C., since the water comprised in the gas stream b is bound in the form of hydrochloric acid. It is therefore possible to cool to relatively low temperatures, for example from −20 to 0° C., than would be possible in the absence of hydrogen chloride in the stream b. Since the hydrochloric acid which condenses out during cooling has only a low vapor pressure, the cooled stream b fed to the drying step c) has only a low water content. This is not unimportant for the subsequent drying step since it results in less desiccant, for example concentrated sulfuric acid, being consumed.

In a step d), the gas stream c is at least partly liquefied by compression and cooling. In general, the two streams are combined and compressed by means of single-stage or multistage compression to a pressure in the range from 5 to 50 bar and simultaneously cooled by means of single-stage or multistage cooling to a temperature in the range from 0 to −70° C. The streams can also be compressed and cooled separately, in which case one or more separately liquefied streams d can result.

In a subsequent gas/liquid separation e), the stream d is separated into a gas stream e1 comprising chlorine, oxygen, carbon dioxide and possibly inert gases and into a liquid stream e2 comprising chlorine, hydrogen chloride, oxygen and carbon dioxide. This step is also referred to as “flash”. The phase separation can be carried out by allowing the gas phase to separate from the liquid phase in a simple vessel. In a preferred embodiment, the gas/liquid separation is effected by introducing the compressed stream d into a column at the top and passing it through the column in countercurrent to the ascending gas phase and feeding part of the chlorine-rich liquid phase leaving the bottom of the column back into the top of the column and thus achieving partial circulation. Preference is given to from 0 to 80% by weight of the chlorine-rich liquid stream taken off at the bottom of the column being circulated, i.e. preferably returned to the column at the top. Carbon dioxide present in the ascending gas stream is dissolved out of the gas stream and can later be separated from chlorine without problems by distillation (together with remaining oxygen). This results in a gas stream e1 which is low in carbon dioxide and can be at least partly recirculated to the oxidation zone. Thus, the substream which is separated off as purge stream from the stream e1 recirculated to the oxidation zone and is discharged from the process in order to prevent accumulation of carbon dioxide can remain comparatively small or preferably be dispensed with altogether, as a result of which the loss of chlorine via the purge streams is also limited. Cooling to very low temperatures in order to condense chlorine virtually completely is not necessary in step d) (“chlorine liquefaction”) since only a small or preferably no purge gas stream is taken off from the stream e1, so that essentially no chlorine can be lost as a result.

The gas stream e1 which has been separated off generally comprises from 1 to 40% by weight of chlorine, from 1 to 40% by weight of hydrogen chloride, from 1 to 80% by weight of oxygen, from 1 to 80% by weight of nitrogen, from 0 to 30% by weight of carbon dioxide and from 0 to 10% by weight of further constituents such as noble gases and carbon monoxide.

The liquid stream e2 generally comprises from 70 to 98% by weight of chlorine, from 1 to 20% by weight of hydrogen chloride, from 0 to 5% by weight of oxygen, from 0 to 30% by weight of carbon dioxide and from 0 to 5% by weight of further constituents such as noble gases and carbon monoxide.

In a step f), the liquid stream e2 is separated into a chlorine stream f1 and a stream f2 consisting essentially of hydrogen chloride, oxygen and carbon dioxide by distillation in a column, with part of the hydrogen chloride being condensed at the top of the column and running back as runback into the column, as a result of which a stream f2 having a chlorine content of <1% by weight, preferably <0.1% by weight, is obtained.

The distillation is generally carried out in a distillation column having, for example, from 5 to 30 theoretical plates at a temperature in the range from −50° C. to +110° C. and a pressure in the range from 4 to 40 bar. The chlorine stream f1 obtained in this way generally has a chlorine content of from 95 to 100% by weight, preferably from 98 to 100% by weight, particularly preferably from 99 to 100% by weight. The stream f2 which consists essentially of hydrogen chloride, oxygen and carbon dioxide is, if appropriate after absorption of the hydrogen chloride comprised therein, discharged from the process as offgas stream.

The hydrogen chloride which has been liquefied with the chlorine allows, when returned as runback from the overhead condenser, virtually complete retention of the chlorine which consequently does not go into the offgas and does not become lost as product of value. A higher overhead temperature of the chlorine distillation column is also possible as a result of the hydrogen chloride reflux.

In one embodiment of the process of the invention, a hydrogen chloride stream is taken off as liquid side offtake stream from the chlorine distillation column and is recirculated to the oxidation zone. This stream can, after depressurization to reactor pressure, serve as coolant in a heat integration apparatus. Preference is given to taking part of the heat from the stream c in this way.

In an optional step g), the gas stream f2 is brought into contact with aqueous hydrochloric acid, preferably the hydrochloric acid II obtained by pressure distillation or vacuum distillation, in a phase contact apparatus and hydrogen chloride is separated off from the stream f2, leaving a gas stream g which consists essentially of oxygen and carbon dioxide and further comprises small amounts of hydrogen chloride and chlorine. In general, the hydrogen chloride content of the stream g is from 100 to 10 000 ppm and the chlorine content is from 10 to 1000 ppm. Since the major part of the inert gases including oxygen have been separated off in the gas/liquid separation step e), only a comparatively small gas volume stream is obtained in the absorption step g), so that a small absorption column is sufficient for the hydrogen chloride separation. The absorption can be carried out at atmospheric pressure, particularly when dilute aqueous hydrochloric acid II from the pressure distillation is used as absorption medium.

In a further optional step h, the gas stream g is brought into contact with a solution comprising sodium hydrogencarbonate and sodium hydrogensulfite and having a pH of from 7 to 9, resulting in chlorine and hydrogen chloride being removed from the gas stream g.

The offgas stream g is preferably brought into contact with a circulating pumped stream comprising sodium hydrogencarbonate and sodium sulfite and having a pH of from about 7.0 to 9.0 in a scrubbing column. The circulating pumped stream is introduced at the top of a scrubbing column. Here, essentially the following (equilibrium) reactions take place:

CO₂+H₂O+NaOH⇄NaHCO₃+H₂O (1)

Cl₂+NaHCO₃⇄NaCl+HOCl+CO₂ (2)

HOCl+Na₂SO₃→NaCl+NaHSO₄ (3)

Part of the bottom offtake stream comprising NaCl, NaHSO₄/Na₂SO₄, NaHSO₃/Na₂SO₃ and NaHCO₃ is discharged. The circulating pumped stream is supplemented with alkaline aqueous sodium sulfite solution. Since only little carbon dioxide is bound by means of this mode of operation, the scrubbing step h consumes comparatively little NaOH.

The invention is illustrated below with the aid of the drawing.

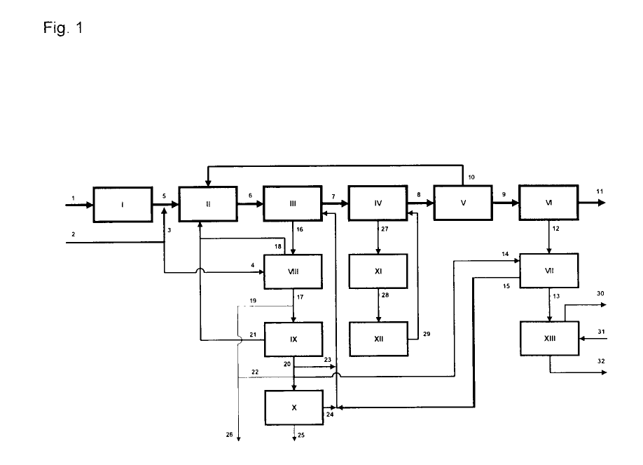

FIG. 1 schematically shows a specific variant of the process of the invention.

### MONOCHLOROBENZENE REMOVAL I

The hydrogen chloride stream 1 which is obtained as coproduct in isocyanate production comprises organic solvents, in particular monochlorobenzene, in amounts of up to 3000 ppm by weight. To remove the monochlorobenzene, the hydrogen chloride stream is passed over a bed of activated carbon. If the hydrogen chloride stream comprises relatively large amounts of organic compounds, these are advantageously condensed out beforehand. The absorption on activated carbon reduces the content of monochlorobenzene to values of <10 ppm. Very much smaller values can also be achieved, depending on the absorbent.

### Reactor II

Oxygen 3, hydrogen chloride 5, circulating gas 10, recycled hydrogen chloride 21 from the hydrochloric acid pressure distillation and the stripping gas from the hydrochloric acid stripper 18 (essentially oxygen) are reacted in the hydrogen chloride oxidation reactor at about 330 to 400° C. and 2 to 8 bar over an RuO₂/Al₂O₃ catalyst. The reactor is configured as a fluidized-bed reactor with internal heat exchangers. The reactor inlet temperature is >200° C. High-pressure steam is generated in the heat exchangers.

### Quench III

The hot reaction gases 6 from the reactor are cooled from the reaction temperature to about 200 to 300° C. in a heat integration apparatus. The precooled product gas mixture goes into a quenching apparatus which has two stages. The first stage is configured as a pipe quench. This comprises vertical tubes, known as pipes, into which the circulating liquid, here aqueous hydrochloric acid having a concentration of from about 29 to 35%, which is present between the tubes is carried by the gas into the tubes. The cooling circulating liquid is broken up into small droplets in the region of the tops of the quenching tubes. As a result of the high turbulence and the large transfer area between gas and liquid, very good heat and mass transfer is achieved. Circulating liquid and gas move in cocurrent. The second, downstream stage is a falling film heat exchanger which is configured as a shell-and-tube apparatus. Reaction gas and circulating liquid (hydrochloric acid) are conveyed in cocurrent through the tubes. The shell-and-tube apparatus is cooled by the means of water. At the bottom of the apparatus, there is a small vessel in which liquid and gas separate. The liquid is recirculated as circulating liquid to the pipe quench apparatus (first stage). In addition, the about 15 to 21% strength constant-boiling aqueous hydrochloric acid 23 obtained in the pressure distillation and the about 20 to 28% strength by weight aqueous hydrochloric acid 24 obtained as azeotropic acid in the vacuum distillation are fed to the pipe quench. The total liquid can be cooled to temperatures of 20 to 40° C. in an additional heat exchanger, e.g. a plate heat exchanger, to reduce the circulating amount or the mixing temperature before introduction into the quench. However, the circulating pumped hydrochloric acid stream corresponds to about 10 to 30 times the amount of the combined recycle streams from the hydrochloric acid distillation.

In the first stage, hydrochloric acid and uncondensed reaction gas are cooled to about 40 to 100° C. In the second stage, further cooling to 10 to 50° C. takes place. The gas mixture leaving the quenching apparatus consists essentially of chlorine, oxygen, carbon dioxide and possibly inert gases and further comprises hydrogen chloride (<15% by volume) and a little water.

### Hydrochloric Acid Pressure Distillation IX

The about 29-35% strength by weight aqueous hydrochloric acid 16 taken off from the quench is stripped by means of the oxygen 4 to free it of chlorine in the hydrochloric acid stripper VIII. The chlorine-comprising oxygen stream 18 is fed to the hydrogen chloride oxidation reactor. The hydrochloric acid which has been freed of chlorine is subsequently subjected to a pressure distillation at about 2-10 bar, giving hydrogen chloride 21 which is recycled to the hydrogen chloride oxidation reactor. The hydrochloric acid 20 is in this way brought down to a hydrogen chloride content of about 15-21% by weight. The total hydrochloric acid is subsequently subjected, if appropriate, to a vacuum distillation X. Part of the 15-21% strength by weight hydrochloric acid 22 can also be blended with part of the chlorine-free stripped 29-35% strength by weight hydrochloric acid 19 to give an in-specification hydrochloric acid 26 and sold.

### Hydrochloric Acid Vacuum Distillation X

In a subsequent vacuum distillation X, the 15-21% strength by weight, constant-boiling aqueous hydrochloric acid is distilled at a pressure of about 0.05-0.2 bar, resulting in it being concentrated to a hydrogen chloride content of about 20 to 28% by weight. Water still comprising traces of hydrogen chloride is taken off at the top of the distillation column. The water 25 is discharged from the process. The 20 to 28% strength by weight aqueous hydrochloric acid is used for absorption of hydrogen chloride from the HCl-comprising overhead stream 12 from the chlorine distillation and subsequently fed to the quench.

The hydrochloric acid vacuum distillation can also be omitted.

### Drying IV

The moist gas stream 7 can be cooled to temperatures of <25° C., preferably <15° C., in an additional heat exchanger located upstream of drying. This significantly reduces the water content of the gas stream. The moist gas stream 7 is dried in countercurrent by means of concentrated sulfuric acid, resulting in the water content being reduced to values of <10 ppm. The dilute aqueous sulfuric acid 27 obtained is stripped by means of dry air and thus freed of chlorine in a small column XI. The dilute aqueous sulfuric acid 28 can subsequently be concentrated by distillation.

### Chlorine Liquefaction V

The dried gas stream 8, which consists essentially of chlorine and oxygen and further comprises hydrogen chloride and inert gases (carbon dioxide, nitrogen), is compressed to about 10 to 40 bar in a plurality of stages. The compressed gas is firstly cooled by means of cooling water, then by means of cold water at about 5 to 15° C. and finally by means of brine to temperatures of from about −10 to −40° C. Between the cold water cooling and the brine cooling, the compressed gas is additionally cooled by means of the depressurized, nonliquefiable gas stream 10 and this gas stream is in the process heated before being recirculated to the reactor.

The compressed and partly liquefied, two-phase mixture is finally separated in a mass transfer apparatus. The unliquefied gas stream is here brought into contact in countercurrent or in cocurrent with the liquid which consists essentially of chlorine and dissolved carbon dioxide, hydrogen chloride and oxygen. As a result, the unliquefied gases are concentrated in the liquid chlorine until thermodynamic equilibrium has been reached, so that inert gases, in particular carbon dioxide, can be separated off via the offgas from the subsequent chlorine distillation.

The unliquefied gas stream 10 is depressurized and is used for cooling the gas stream.

### Chlorine Distillation VI

The liquefied chlorine 9 having a chlorine content of >85% by weight is subjected to a distillation at about 10-40 bar. The temperature at the bottom is from about 30 to 110° C., and the temperature at the top is, depending on the hydrogen chloride content of the liquefied chlorine, in the range from about −5 to −8° C. and from about −25 to −30° C. At the top of the column, hydrogen chloride is condensed and allowed to run back into the column. Virtually complete separation of chlorine is achieved as a result of the HCl reflux, so that the chlorine loss is minimized. The chlorine 11 which is taken off at the bottom of the column has a purity of >99.5% by weight. This is vaporized and subsequently fed, for example, to an isocyanate production plant where it is converted into phosgene. As an alternative, the liquid chlorine can also be cooled and stored in liquid form.

The gaseous overhead stream 12 from the chlorine distillation comprises about 40-85% by weight of hydrogen chloride together with oxygen and carbon dioxide.

### Hydrogen Chloride Absorption VII

The hydrogen chloride from the offgas stream 12 from the chlorine distillation is absorbed by bringing it into contact with about 15-21% strength by weight aqueous hydrochloric acid from the pressure distillation. The hydrochloric acid is recirculated to the quench. The remaining offgas comprising inerts (N₂, Ar), oxygen, carbon dioxide, small amounts of hydrogen chloride and traces of chlorine is subsequently freed of residual chlorine and HCl by scrubbing with alkaline aqueous sodium hydrogen sulfite solution in an offgas scrub.

### Sulfite Scrub XIII

In a scrubbing column, the offgas stream 13 is brought into contact with a circulating pumped stream comprising sodium hydrogencarbonate and sodium sulfite and having a pH of about 8-10. The circulating pumped stream is introduced at the top of the scrubbing column. Part of the bottom offtake stream comprising NaCl, NaHSO₄, NaHSO₃ and NaHCO₃ is discharged. The circulating pumped stream is supplemented with alkaline aqueous sodium sulfite solution.

### Circulating Gas Treatment

The unliquefied circulating gas 10 from the chlorine liquefaction can be freed of undesirable constituents which can, for example, act as catalyst poison in an additional step, e.g. by absorption, adsorption or by means of a membrane. In addition, the circulating gas can be freed of chlorine and HCl by means of targeted removal of HCl by absorption and chlorine, e.g. by membrane separation, and be discarded in its entirety.

1. A process for preparing chlorine from hydrogen chloride, which comprises the steps:
a) feeding a stream a1 comprising hydrogen chloride and a stream a2 comprising oxygen into an oxidation zone and catalytically oxidizing said hydrogen chloride to chlorine, giving a product gas stream a3 comprising chlorine, water, oxygen, carbon dioxide and inert gases;
b) contacting the product gas stream a3 with aqueous hydrochloric acid I in a phase contact apparatus and partially separating water and hydrogen chloride from the stream a3, leaving a gas stream b comprising hydrogen chloride, chlorine, water, oxygen, carbon dioxide and possibly inert gases, with at least 5% of the hydrogen chloride comprised in the stream a3 remaining in the gas stream b;
c) drying of the gas stream b) to leave a gas stream c which is substantially free of water and comprises hydrogen chloride, chlorine, oxygen, carbon dioxide and possibly inert gases;
d) partial liquefaction of the gas stream c by compression and cooling, giving an at least partially liquefied stream d;
e) gas/liquid separation of the stream d into a gas stream e1 comprising chlorine, oxygen, carbon dioxide, hydrogen chloride and possibly inert gases and a liquid stream e2 comprising hydrogen chloride, chlorine, oxygen and carbon dioxide and, optionally, recirculation of at least part of the gas stream e1 to step a); and
f) separating by distillation in a column the liquid stream e2 into a chlorine stream f1 and a stream f2 consisting essentially of hydrogen chloride, oxygen and carbon dioxide, with part of the hydrogen chloride condensing at the top of the column and running back as runback into the column, as a result of which a stream f2 having a chlorine content of <1% by weight is obtained.

2. The process according to claim 1, wherein the aqueous hydrochloric acid used in step b) has a hydrogen chloride concentration of from 27 to 35% by weight.

3. The process according to claim 1, wherein at least part of the aqueous hydrochloric acid circulating in the phase contact apparatus is taken off from the phase contact apparatus and subsequently distilled to give gaseous hydrogen chloride and an aqueous hydrochloric acid II which has been depleted in hydrogen chloride, with the hydrogen chloride being recirculated to step a) and at least part of the aqueous hydrochloric acid II being recirculated to the phase contact apparatus.

4. The process according to claim 3, wherein the aqueous hydrochloric acid I taken off from the phase contact apparatus is stripped to make it essentially chlorine-free before the hydrochloric acid distillation is carried out.

5. The process according to claim 4, wherein part of the stripped, essentially chlorine-free hydrochloric acid I is separated off before the hydrochloric acid distillation is carried out and is combined with part of the aqueous hydrochloric acid II obtained in the hydrochloric acid distillation.

6. The process according to claim 4, wherein the aqueous hydrochloric acid I is stripped to make it essentially chlorine-free by means of at least part of the oxygen-comprising stream a2.

7. The process according to claim 1, wherein the gas/liquid separation in step e) is effected by introducing the compressed stream d into a column at the top and recirculating part of it, with the oxygen dissolved in the chlorine-rich liquid stream and any dissolved inert gases being stripped out of the descending liquid stream by the gas stream ascending in the column, and carbon dioxide present in the ascending gas stream being simultaneously dissolved out of the gas stream by the descending liquid stream.

8. The process according to claim 1, wherein, in a step g), the gas stream f2 is brought into contact with aqueous hydrochloric acid in a phase contact apparatus and hydrogen chloride is separated off from the stream f2, leaving a gas stream g which consists essentially of oxygen and carbon dioxide and further comprises small amounts of hydrogen chloride and chlorine.

9. The process according to claim 8, wherein, in an additional step h), the gas stream g is brought into contact with a solution comprising sodium hydrogencarbonate and sodium hydrogen sulfite having a pH of from 7 to 9, resulting in chlorine and hydrogen chloride being removed from the gas stream g.
